(19) United States
(12) Patent Application Publication
(10) Pub. No.: US 2026/0332416 A1
(43) Pub. Date: Oct. 22, 2026

(54) SYSTEM AND METHOD FOR PRIVACY-PRESERVING EQUITY MANAGEMENT USING ZERO-KNOWLEDGE PROOFS WITH SCHEMA-PER-TENANT ISOLATION AND METERED CRYPTOGRAPHIC OPERATIONS

(71) Applicant: John Carl Reynolds, Fontana, CA (US)

(72) Inventor: John Carl Reynolds, Fontana, CA (US)

(21) Appl. No.: 19/646,078

(22) Filed: Apr. 13, 2026

(51) Int. Cl. H04L 9/32

(52) U.S. Cl. CPC H04L 9/3218; H04L 9/3236; H04L 9/3247

(57) ABSTRACT

A privacy-preserving equity management system and method utilize a schema-per-tenant isolation architecture and zero-knowledge proofs (ZKP) to ensure data invisibility. The system implements dedicated database schemas for each tenant to prevent cross-tenant data leakage. A ZKP framework utilizing NOIR circuit constraints enables verification of equity data without exposing underlying records, employing a multi-stage transformation pipeline with Pedersen commitments on a BN254/Grumpkin elliptic curve pair. A functional seeded sandbox environment provides atomic-metered ZKP generation using mock records under production-identical security constraints. Access control and monetization are governed by a computationally invariant four-gate middleware, utilizing a global configuration mechanism to toggle between operational states via a single compile-time boolean constant. Complementary privacy layers including an Encrypted View system with HMAC-SHA-256 hashing provide visual data protection as part of a three-layer privacy stack. Testing and validation infrastructure maps automated tests to cryptographic security properties. Version lock documentation ensures reproducibility across software updates.

### CROSS-REFERENCE TO RELATED APPLICATIONS

This application is the first filing in a series of related patent applications. Related applications covering platform operations and progressive onboarding (Patent B) and AI-driven intent pipeline with computational governance (Patent C) claim priority to this application's filing date for overlapping subject matter.

### FIELD OF THE INVENTION

This invention relates generally to cloud-based financial data management and, more particularly, to a system and method for privacy-preserving equity management using isolated data architectures and zero-knowledge cryptographic proofs.

### BACKGROUND OF THE INVENTION

The field of equity management for private companies has long been plagued by significant challenges in maintaining the privacy and security of sensitive stakeholder data. Traditional cap table management platforms, such as those offered by competitors like Carta and Cake Equity, often rely on centralized data storage models where sensitive information—such as ownership stakes, investor identities, and transaction details—is stored in databases accessible to platform administrators or vulnerable to breaches. This “public-by-default” approach poses substantial risks for stealth startups, high-net-worth investors, and pre-IPO companies, who cannot afford their proprietary equity structures to be exposed to competitors or compromised through data leaks.

High-profile incidents reported by other conventional equity management systems, have further eroded trust in centralized systems, highlighting the potential for even the perception of privileged access to damage market confidence.

Moreover, existing solutions frequently depend on conventional encryption and role-based access controls, which, while offering some protection, still permit data processing by employees or subprocessors, as acknowledged in privacy policies of major platforms. This inherent visibility undermines the sovereignty of company data, particularly in regulated jurisdictions like the European Union, where GDPR imposes stringent requirements on data residency and exposure, or in the United States, where SEC regulations (e.g., Regulation S-P) mandate robust incident response and breach notification protocols. Manual processes, such as Excel spreadsheets and email-based transfers, exacerbate these issues by introducing human error and further security vulnerabilities, often costing companies significant administrative overhead with fees ranging from 15,000¿50,000 annually for legacy transfer agent services.

Additionally, traditional platforms suffer from onboarding friction that impedes adoption of advanced privacy technologies. Users of Zero-Knowledge Proof systems face a “cold start” problem: without real data loaded into the system, they cannot experience or validate the privacy guarantees that differentiate the platform. Existing competitors address this gap, if at all, through static demonstrations or manual guided tours that do not expose the user to live cryptographic operations. The absence of functional trial environments for privacy-preserving equity systems represents a significant barrier to adoption for stealth startups and pre-IPO entities.

The need for a transformative solution in equity management is evident—one that prioritizes data invisibility by design, eliminates centralized points of exposure, automates compliance with regulatory frameworks, and provides immediate, functional onboarding into privacy-preserving environments. Such a solution must empower founders and stakeholders with control over their sensitive information, while providing a seamless, scalable user experience that addresses the inefficiencies of outdated systems. The present invention seeks to address these critical gaps by introducing a novel approach to privacy and security in cap table management, fundamentally redefining trust and sovereignty in the fintech landscape.

### BRIEF SUMMARY OF THE INVENTION

The present invention is a privacy-first equity management platform designed to address the critical security and trust deficiencies inherent in traditional cap table management systems. Unlike conventional platforms that rely on centralized data storage models susceptible to breaches and unauthorized access, the platform introduces a novel architecture that prioritizes data invisibility and user sovereignty through advanced cryptographic techniques and isolated data environments. At the core of the system is a Schema-per-Tenant isolation architecture, which ensures complete separation of stakeholder data by maintaining dedicated database schemas for each user or tenant, thereby preventing cross-tenant data leakage and enhancing security in a multi-tenant SaaS environment.

The platform leverages Zero-Knowledge Proofs (ZKPs) implemented through the NOIR circuit framework to enable privacy-preserving verification of equity data, such as ownership thresholds or transaction compliance, without exposing sensitive underlying information to platform administrators or external parties. This cryptographic approach fundamentally differentiates the invention from existing solutions by ensuring that even the system itself remains blind to raw data during processing and verification. Additionally, the invention features a functional Seeded Sandbox environment that provides new users with a controlled, simulated cap table experience, allowing them to generate and verify atomic-metered ZK proofs using mock data under the same security constraints as the production environment, thus building trust and facilitating onboarding for stealth startups and pre-IPO entities unfamiliar with advanced privacy technologies.

The platform incorporates a computationally invariant four-gate middleware for access control and monetization, governed by a global Dual-Configuration Feature Gate. This mechanism utilizes a single compile-time boolean constant (BETA_MODE) to toggle between Beta and Production configurations, enabling a simultaneous, state-wide transition that activates a monetization wall across all tenant schemas without altering underlying code paths. The four-gate middleware enforces sequential validation through authentication, tenant resolution, subscription verification, and feature-flag evaluation gates on every API request. This kill switch pattern offers a seamless shift from open beta access to tiered, paid access, ensuring scalability and business model flexibility.

Complementary privacy layers, including an Encrypted View system with HMAC-SHA-256 hashed display formats and custom privacy labels, provide additional visual data protection as part of a three-layer privacy stack alongside schema isolation and ZKP verification. A rigorous testing and validation infrastructure maps automated tests to cryptographic security properties including soundness, binding, public input integrity, and completeness. Version lock documentation ensures reproducibility of cryptographic operations across software updates.

The core infrastructure described herein further supports progressive onboarding pipelines, multi-organization membership with schema-routed role-based access control, subscription-integrated monetization, multi-instrument equity management, and AI-driven inference interfaces—each described in detail in related patent applications that claim priority to this filing.

### BRIEF DESCRIPTION OF THE DRAWINGS

FIG. 1 is a system architecture diagram depicting the multi-layered component interaction flow of the privacy-preserving equity management platform, showing the User Device, Four-Gate Middleware, Application Server, NOIR Circuit Engine, a plurality of isolated tenant Database Schemas across browser, server, and database layers, and an optional Inference Interface for natural-language-to-middleware translation.

FIG. 2 is a block diagram of the Seeded Sandbox environment, illustrating the seedZkpData( ) Initialization Function, Mock Securities Data Store, Privacy Vault Interface, and Proof Allocation Meter—configured as a Computational Governor for both manual and external inference agents—within a tenant's isolated schema.

FIG. 3 is a method flow diagram depicting the sequential steps of authenticated Zero-Knowledge Proof generation—initiated via a manual user action or an AI-driven inference agent—from user authentication and tenant schema initialization through proof request, allocation verification, server-side circuit execution, and Verification URL return.

FIG. 4 is a detailed process diagram of the proof generation and atomic usage tracking pipeline, showing the source-aware Incoming Proof Request with request_source field (distinguishing MANUAL and AI_HAYLO values), circuit parameter validation, ownership_threshold circuit execution, proof record storage via createProofResult( ), and the separate atomic usage increment via PostgreSQL upsert through incrementProofUsage( ).

FIG. 5 is a state transition diagram of the Security Ritual UX, depicting the five interface states—IDLE, PROCESSING, 98% CAP, VERIFIED, and ERROR—with transitions governed by user input, progress threshold, server-side proof completion, and failure conditions, including the requestAnimationFrame-based progress cap mechanism.

FIG. 6 is a data flow diagram of the Encrypted View privacy toggle system, depicting the three-layer privacy stack (Schema Isolation, ZKP Verification, Visual Masking), the HMAC-SHA-256 hashing flow from normal view to masked view using companyId as the HMAC key, the display priority chain (Label over Hash over Placeholder), and the role-based access control governing label editing.

FIG. 7 is a logical gate architecture diagram of the Four-Gate Middleware (12), depicting the sequential pipeline of Gate 1—Contextual Identity Isolation (400), Gate 2—Schema-Bound Query Translation (402), Gate 3—Policy Enforcement and ZKP Check (404) with Computational Governor for external inference agents, and Gate 4—Closed-Loop Feedback and Verification (406), with reject paths for unauthorized or meter-exhausted requests.

FIG. 8 is a structural transformation diagram of the ZKP data transformation pipeline, depicting three sequential cryptographic stages within the server-side execution boundary of the Application Server (20): a Pedersen Commitment Stage (300) that generates a commitment C=v·G+s·H from a raw equity value and a 32-byte random salt using Grumpkin curve generators, providing computational binding and information-theoretic hiding; a BN254 Elliptic-Curve Hashing Stage (302) that maps the Pedersen commitment onto the BN254 scalar field for circuit compatibility, enabling arithmetic constraints within NOIR circuits; and a Grumpkin Verification Artifact Generation Stage (304) that produces a compact proof artifact via the UltraHonk proof protocol, suitable for on-chain or off-chain verification, wherein private inputs including equity values and salts never leave the server boundary.

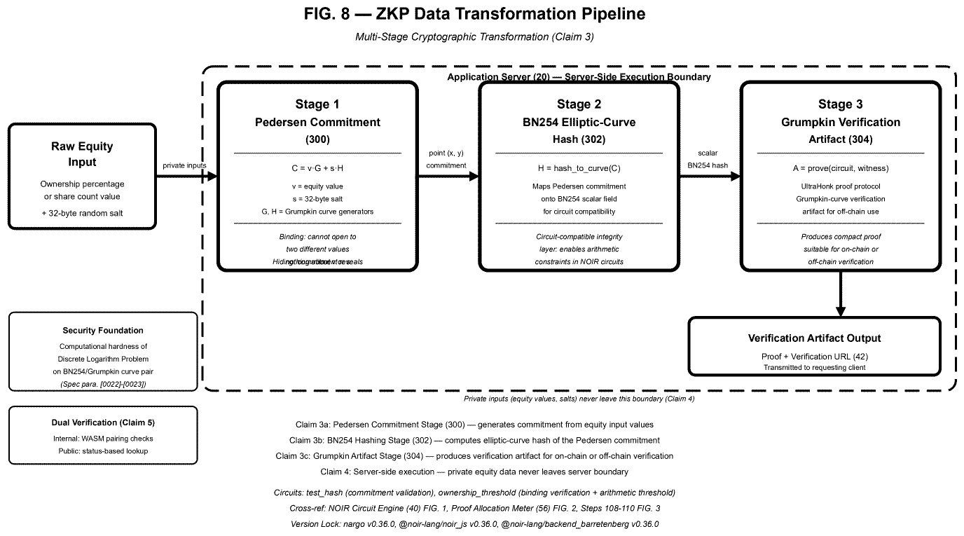

### DETAILED DESCRIPTION

The present invention provides a privacy-first equity management platform utilizing a Schema-per-Tenant isolation architecture to ensure complete cryptographic separation of stakeholder data. The system features a functional Sandbox environment allowing for atomic-metered Zero-Knowledge (ZK) proof generation using identical NOIR circuit constraints as the production environment. Access and monetization are managed via a computationally invariant four-gate middleware, controlled by a global Dual-Configuration Feature Gate that allows for a simultaneous, state-wide transition between Beta and Production configurations without modification to the underlying code paths.

### 1. Overview of the System Architecture

The platform is designed to address the critical privacy and security gaps in traditional cap table management by introducing a multi-layered, cryptographically secure architecture tailored for private companies, including stealth startups and pre-IPO entities. The system operates as a cloud-native Software-as-a-Service (SaaS) platform, leveraging advanced infrastructure to deliver scalability, efficiency, and regulatory compliance. At its foundation, the platform employs a Schema-per-Tenant isolation architecture, implemented through PostgreSQL schemas (e.g., tenant_{slug} as defined in server/tenant. ts), ensuring that each tenant's data—such as equity records, stakeholder identities, and transaction details—resides in a dedicated, isolated database schema. This design prevents cross-tenant data leakage, a significant risk in conventional multi-tenant systems, and aligns with stringent data residency requirements such as those imposed by GDPR in the European Union.

The system's architecture is composed of multiple functional layers, as detailed in a comprehensive component inventory. These layers include Noir circuits for ZKP generation, a server-side proof engine, data schema and storage modules, seeding scripts for onboarding, frontend ZKP interaction pages, privacy mode toggles, and sidebar integrations, spanning 24 specific files across the codebase. Each layer interacts seamlessly through defined API call paths and data flows, ensuring that sensitive operations, such as proof generation and verification, maintain data invisibility even to platform administrators.

### 2. Schema-per-Tenant Isolation for Data Security

Central to the platform's security model is the Schema-per-Tenant isolation mechanism, which creates a distinct PostgreSQL schema for each tenant upon account creation (via CREATE SCHEMA tenant_{slug}). This approach, unlike horizontal sharding or shared database models common in legacy platforms, ensures complete cryptographic and logical separation of data. Each schema contains a full set of over twenty tables specific to the tenant, including equity records, commitment hashes, and proof usage tracking, preventing any cross-tenant access or data exposure. This isolation is further enforced through tenant-specific middleware (tenantMiddleware in the codebase), which resolves tenant context from session data (stored via express-session and connect-pg-simple) and applies defense-in-depth tenantId checks to restrict operations to the active schema. This architecture serves as a critical “storage moat,” providing a robust defense against unauthorized access and aligning with regulatory mandates for data protection.

### 3. Zero-Knowledge Proofs via NOIR Circuit Framework

The platform revolutionizes equity management by integrating Zero-Knowledge Proofs (ZKPs) through the NOIR circuit framework, enabling privacy-preserving operations on sensitive data. The system processes equity data—such as ownership percentages or transfer validity—into cryptographic commitments without exposing raw information, even during verification. NOIR operates primarily on the server-side (contrary to initial assumptions of client-side processing), as detailed in the codebase (proof-service. ts), for reasons including private input containment, large circuit artifact sizes, and WASM memory management constraints. The process involves a five-stage data transformation pipeline: raw cap table record to salt generation (32-byte random salts), SHA-256 commitment hash for fast integrity, Pedersen commitment for circuit compatibility (using the BN254 elliptic curve pair, with Pedersen operations computed on the embedded Grumpkin curve for binding and hiding properties), and finally, stored state in the database.

Two primary Noir circuits underpin this functionality: test_hash for commitment validation leveraging the computational hardness of the Discrete Logarithm Problem on the Grumpkin/BN254 curve pair, and ownership_threshold for binding verification and arithmetic threshold enforcement within the zero-knowledge constraint system (e.g., verifying if a stakeholder owns at least a specified number of shares via u64 comparison). Proof generation employs the UltraHonk protocol, with performance optimizations such as circuit caching and TanStack Query caching to ensure scalability for a growing user base. Security measures, including tamper resistance and UUID unpredictability, protect proof integrity, while verification is offered through dual paths: internal cryptographic re-verification (via WASM pairing checks for authenticated users) and public status-based lookups (unauthenticated, efficient endpoint in proof-routes. ts with CORS and rate limiting). This ZKP system ensures that sensitive data remains invisible, addressing a core deficiency in traditional platforms like Carta, where data exposure is a persistent risk.

### 4. Functional Seeded Sandbox for User Onboarding

The platform introduces a novel Seeded Sandbox environment designed to facilitate user onboarding by providing a controlled, simulated cap table management experience that builds trust in the platform's privacy-first model. This feature is particularly critical for stealth startups and pre-IPO companies unfamiliar with advanced cryptographic technologies like Zero-Knowledge Proofs (ZKPs). The Sandbox, implemented via the seedZkpData( ) function in the codebase, seeds mock equity data (e.g., 4 securities with random 32-byte salts and SHA-256 commitment hashes) into a tenant's isolated schema upon account creation. This mock data mirrors realistic cap table structures, allowing users to interact with the system's privacy features without risking exposure of real equity information.

A distinguishing aspect of the Sandbox is its ability to support a functional cryptographic trial, where pre-seeded synthetic proofs (identified by a seed_demo_ prefix) and live-generated proofs coexist within the same verification pipeline. Synthetic proofs do not require Noir circuit execution, avoiding WASM latency during initial onboarding, while live proofs—limited to a metered allocation (e.g., 10 per month in beta mode as defined in proof-config.ts)—utilize real cryptographic operations against seeded data. This allocation is tracked server-side via an atomic PostgreSQL upsert (incrementProofUsage( ) in storage.ts), ensuring failed attempts do not deplete the user's limit, a reliability feature that enhances user experience. The Sandbox operates under identical security constraints as the production environment, with time-to-live (TTL) differences (1 year for demo proofs vs. 72 hours for real proofs) to manage data persistence.

The user journey in the Sandbox includes generating and verifying ZK proofs through a tailored interface, supported by a Security Ritual UX (implemented in PrivacyVault.tsx) that guides users through proof generation with visual feedback (e.g., requestAnimationFrame-based animations capped at 98% to indicate near-completion). This onboarding mechanism not only reduces the learning curve but also demonstrates the system's mathematical integrity, positioning the platform as a unique solution compared to competitors like Carta, who lack interactive, privacy-preserving trial environments.

### 5. Dual-Configuration Feature Gating for Access and Monetization

The platform incorporates a sophisticated access control and monetization mechanism through a computationally invariant four-gate middleware architecture, governed by a global Dual-Configuration Feature Gate. This system, detailed in proof-middleware.ts and proof-config.ts, manages user permissions and billing for ZKP generation and verification events. The middleware operates through four distinct gates: a frontend feature flag to enable/disable UI elements, a server-side tier configuration check (based on tenant plan), the checkProofAccess middleware to enforce limits, and race-condition-proof usage tracking via atomic PostgreSQL upserts (INSERT . . . ON CONFLICT DO UPDATE in storage.ts). This ensures that only successful proof generations increment the usage meter, protecting users from penalties for system failures.

Central to this mechanism is a single compile-time boolean constant, BETA_MODE (set to true or false on line 7 of proof-config.ts), which toggles the permission matrix between Beta and Production configurations. In Beta mode, all tiers have access to a set allocation (e.g., 10 proofs/month), while in Production mode, access is restricted to paid tiers based on subscription levels (PROOF_TIER_BETA vs. PROOF_TIER_PRODUCTION in proof-config.ts). The middleware remains invariant, executing identical logic paths regardless of mode, with only the tier-limit data retrieved changing based on the BETA_MODE flag at module load time. This “kill switch” pattern enables a simultaneous, state-wide transition across all tenant schemas without code modifications, deployment differences, or per-tenant migrations, activating a monetization wall instantly when switched to Production mode.

This innovative approach to SaaS monetization provides scalability and flexibility, distinguishing the platform from traditional equity management platforms.

### 6. Complementary Privacy Layers with Encrypted View System

Beyond ZKPs and schema isolation, the platform implements a complementary privacy layer through an Encrypted View system to further protect sensitive data during user interactions. This system, integrated into the frontend (PrivacyModeToggle.tsx), employs HMAC-SHA-256 hashing with companyId as the key to obscure displayed data (e.g., stakeholder identities or share counts) in visual interfaces. It features truncated display formats and custom privacy labels (e.g., XXXX-XXXX with an unambiguous charset), adhering to a display priority chain (label>hash>placeholder) to balance usability and security. Toggle persistence is managed via localStorage, and role-based access control dictates visibility (e.g., staff can view, admins can edit), ensuring granular protection.

This Encrypted View operates as part of a three-layer privacy stack alongside Schema-per-Tenant Isolation and ZKP verification, each addressing distinct threat vectors (e.g., database leaks, visual exposure, data processing). The combined user journey—from login to proof generation—ensures data remains protected at every interaction point, with no coupling between layers to maintain separation. This multi-layered approach enhances the platform's defensibility against data exposure risks prevalent in centralized systems like Carta.

### 7. Testing and Validation Infrastructure for System Reliability

The platform incorporates a robust testing and validation infrastructure to ensure the reliability, security, and cryptographic integrity of its privacy-first equity management platform. This infrastructure, detailed in the system documentation, is critical for demonstrating the utility and soundness of the invention to regulatory bodies and potential stakeholders. At the foundational level, a Gate 0 smoke test verifies the NoirJS pipeline, ensuring the core Zero-Knowledge Proof (ZKP) generation and verification processes function as intended before further integration. This is complemented by a comprehensive 5-test cryptographic unit suite that evaluates key system behaviors, including positive case validation (successful proof generation and verification), rejection handling (invalid inputs or constraints), mismatch detection (commitment discrepancies), tampering resistance (altered proof rejection), and threshold enforcement (e.g., ownership percentage checks via ownership_threshold circuit).

A security properties table maps these tests to essential cryptographic guarantees: soundness (proofs cannot be faked), binding (commitments cannot be altered post-generation), public input integrity (visible data remains consistent), and completeness (valid inputs always produce verifiable proofs). This rigorous validation framework, implemented across the codebase, underpins the platform's reliability, distinguishing it from traditional platforms like Carta, where such cryptographic testing is absent due to their lack of ZKP architecture. Additionally, a commitment generation CLI tool allows developers to simulate and debug commitment creation outside the live environment, further ensuring system stability. These testing mechanisms provide concrete evidence of the invention's operational integrity, supporting patent utility under USPTO requirements.

### 8. System Component Interactions and Data Flow

The seamless operation of the platform's privacy-first architecture relies on well-defined interactions between its multi-layered components, ensuring data invisibility and user sovereignty at every stage. The system is structured across three primary layers: the browser layer (user interface), the server layer (processing and middleware), and the database layer (isolated storage). The browser layer includes four key pages and components (e.g., PrivacyVault.tsx for proof generation, PrivacyModeToggle. tsx for encrypted display), a custom hook for ZKP interactions, and a sidebar integration for navigation, all facilitating user engagement with privacy features. The server layer comprises API routes (proof-routes.ts), proof services (proof-service.ts), middleware for access control (proof-middleware.ts), configuration settings (proof-config.ts), and a WASM backend for cryptographic operations, handling the core logic of ZKP generation and verification. The database layer maintains a plurality of per-tenant tables within each isolated schema—over twenty tables including equity records, commitment hashes, proof requests, proof results, and proof usage tracking—ensuring data separation.

Data flow begins with user input in the browser (e.g., initiating a proof request via the Privacy Vault page), which triggers an API call to the server through authenticated routes (protected by requireAuth and tenantMiddleware). The server resolves tenant context from session data, applies the four-gate access control (feature flag, tier config, access check, usage tracking), and processes the request—either generating a ZKP using Noir circuits or retrieving a pre-seeded synthetic proof for Sandbox users. Results are stored in the tenant's isolated schema and returned to the browser for display, with sensitive data obscured via the Encrypted View system. Public verification requests (unauthenticated) bypass proof generation, using a status-based lookup endpoint for efficiency. This end-to-end flow, mapped in detailed interaction diagrams, ensures privacy at every touchpoint, providing a scalable, secure framework that redefines equity management compared to centralized alternatives.

### 9. Version Control and Reproducibility for Patent Evidence

To support the reproducibility and long-term validity of the system as required for patent enablement, the platform includes strict version lock documentation for its cryptographic dependencies. Core components such as nargo, noir_js, and backend_barretenberg are locked at version 0.36.0, ensuring consistent behavior of ZKP generation and verification processes across development and production environments. Upgrade procedures are defined to maintain compatibility and security, with version-specific artifacts (e.g., compiled ownership_threshold.json) preserved to replicate the system's state at the time of filing. This meticulous versioning provides concrete evidence for USPTO examiners to verify the invention's functionality, reinforcing the patent's technical credibility and distinguishing the platform from less rigorously documented systems in the equity management space.

### DETAILED DESCRIPTION OF EMBODIMENTS IN DRAWINGS

The following embodiments illustrate specific implementations of the privacy-first equity management platform, as described in the foregoing sections. These embodiments are provided to enable one of ordinary skill in the art to make and use the invention and are not intended to limit the scope of the claims. Variations and modifications within the spirit and scope of the invention are contemplated and included.

### Embodiment 1: Founder Onboarding via Seeded Sandbox

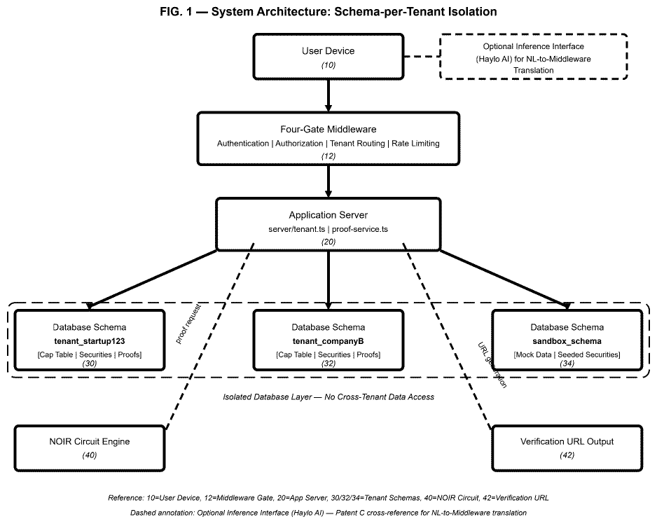

As shown in FIG. 1, in a first embodiment, a founder of a stealth startup accesses the platform from a User Device (10) to manage their company's cap table with privacy as a priority. Upon account creation, the request passes through the Four-Gate Middleware (12), which enforces Authentication, Authorization, Tenant Routing, and Rate Limiting before reaching the Application Server (20). The Application Server (20) initializes a dedicated Database Schema (30) (e.g., tenant_startup123 via server/tenant.ts) for the founder's company, ensuring Schema-per-Tenant Isolation, whereby each tenant's data resides in a structurally separated schema (30, 32, 34) with no cross-tenant data access.

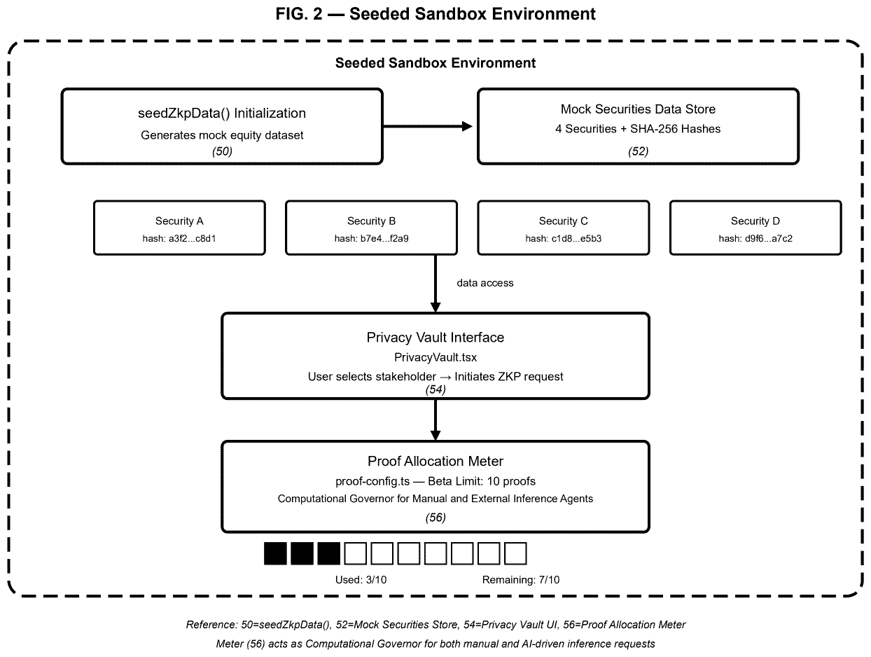

As further shown in FIG. 2, the founder is directed to the Seeded Sandbox environment, where mock equity data (e.g., 4 securities with SHA-256 commitment hashes) is pre-seeded into the Mock Securities Data Store (52) using the seedZkpData( ) Initialization Function (50). The founder interacts with the Privacy Vault Interface (54) (PrivacyVault.tsx) to initiate a live Zero-Knowledge Proof (ZKP) generation cycle, limited to a metered allocation (e.g., 10 proofs in beta mode) as enforced by the Proof Allocation Meter (56) (per proof-config.ts).

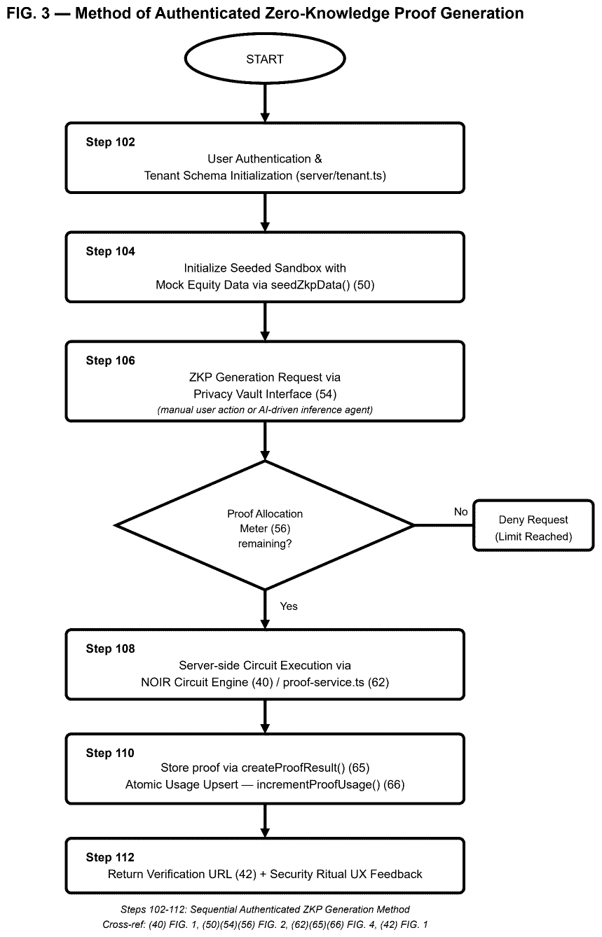

Referring to FIG. 3, the method proceeds through sequential steps: at Step 102, the system authenticates the user and initializes the tenant schema; at Step 104, the Seeded Sandbox is initialized with mock equity data; at Step 106, the user requests ZKP generation via the Privacy Vault Interface (54). If the Proof Allocation Meter (56) confirms remaining allocation, the process advances to Step 108, where the Application Server (20) processes the request server-side (proof-service.ts), invoking the NOIR Circuit Engine (40) to generate a proof using the ownership_threshold circuit to verify a mock stakeholder's ownership percentage without exposing underlying data.

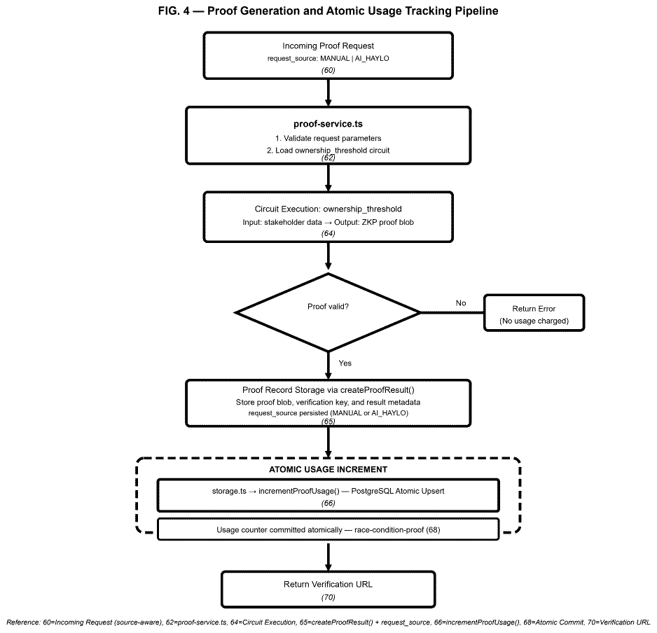

As illustrated in FIG. 4, at Step 110, upon successful proof generation, the proof record is stored via createProofResult( ) (65). The usage counter is then updated via an atomic PostgreSQL upsert (incrementProofUsage( ) in storage.ts) (66), where the usage increment is committed atomically (68) to ensure race-condition-proof billing accuracy. Upon successful commit, a Verification URL (42) is returned at Step 112 for sharing with a potential investor.

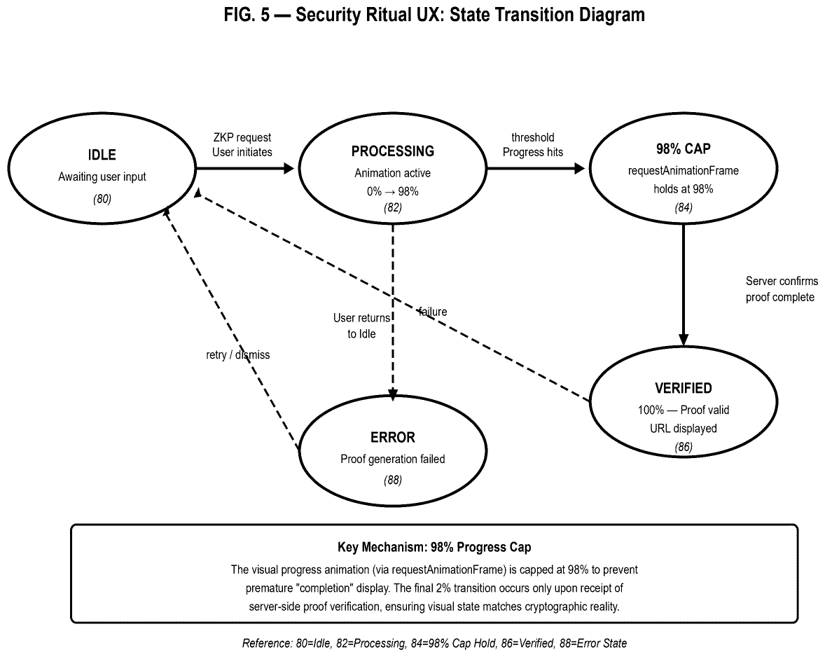

As depicted in FIG. 5, the Security Ritual UX guides the founder through the process with visual feedback. The interface transitions from the IDLE state (80) to the PROCESSING state (82), where the progress animation advances from 0% to 98%. Upon reaching the threshold, the system enters the 98% CAP state (84), where the display is held via requestAnimationFrame to prevent premature completion indication. Only upon receipt of server-side proof verification from the Application Server (20) does the interface transition to the VERIFIED state (86), displaying the Verification URL (42) at 100% and building trust in the platform's privacy capabilities before the founder transitions to live data management.

### Embodiment 2: Public Verification by External Party

In a second embodiment, as shown in FIG. 1, an external auditor or investor receives a Verification URL (42) from a platform user to confirm an equity-related statement (e.g., ownership threshold) without accessing sensitive data. Unlike the authenticated flow of Embodiment 1, the external party's User Device (10) directs to a public verification endpoint (proof-routes.ts) on the Application Server (20), which is unauthenticated and rate-limited for efficiency —bypassing the full Four-Gate Middleware (12) authentication and authorization gates while retaining the Rate Limiting gate.

Referring to FIG. 1, the Application Server (20) performs a status-based lookup on the stored proof (identified by a unique proofId) within the tenant's isolated Database Schema (30), bypassing cryptographic re-verification via the NOIR Circuit Engine (40) to minimize computational overhead. The Schema-per-Tenant Isolation ensures the lookup is confined to the originating tenant's schema (30), with no cross-tenant data access to adjacent schemas (32, 34).

The result is displayed on a public page (PublicVerify.tsx) with one of four states corresponding to the Security Ritual UX state model depicted in FIG. 5:“Verified” (mapping to the VERIFIED state (86)), “Invalid” (mapping to the ERROR state (88)), “Expired,” or “Not Found”—ensuring no raw data or tenant-specific information is exposed. This embodiment demonstrates the platform's dual verification paths—internal for authenticated users routed through the Four-Gate Middleware (12), and public for external parties with direct access to the Verification URL Output (42)—enhancing accessibility while maintaining data invisibility.

### Embodiment 3: Monetization Activation via Dual-Configuration Gating

In a third embodiment, as shown in FIG. 1 and FIG. 2, the platform administrator transitions the platform from Beta to Production mode to activate monetization across all tenant Database Schemas (30, 32, 34). Initially set to BETA_MODE=true in proof-config.ts, the system allows all tiers a metered allocation of ZKP generations (e.g., 10 proofs/month) as enforced by the Proof Allocation Meter (56). Upon updating the compile-time boolean constant to BETA_MODE=false, the permission matrix switches to the Production configuration (PROOF_TIER_PRODUCTION), restricting access to paid tiers only.

Referring to FIG. 1, this state-wide transition occurs simultaneously for all tenants across their isolated Database Schemas (30, 32, 34) without code path changes, as the computationally invariant Four-Gate Middleware (12)—specifically the checkProofAccess function in proof-middleware.ts—retrieves updated tier-limit data while executing identical Authentication, Authorization, Tenant Routing, and Rate Limiting logic. The Application Server (20) processes all requests through the same middleware gates regardless of Beta or Production configuration, ensuring no divergence in the security enforcement path.

As illustrated in FIG. 4, usage tracking remains atomic via the PostgreSQL upsert mechanism in storage.ts (incrementProofUsage( )) (66), where the usage counter is committed atomically (68), ensuring billing accuracy across all tenant schemas. This “kill switch” mechanism enables seamless monetization scaling, distinguishing the platform's SaaS model from static access systems in equity management.

### Embodiment 4: Privacy-Preserving Identity Masking via Encrypted View

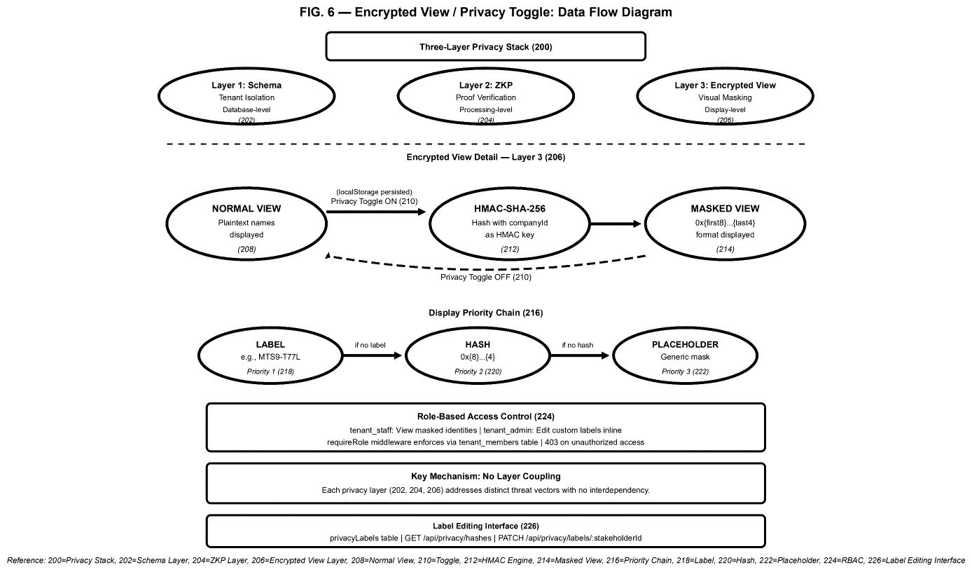

In a fourth embodiment, as shown in FIG. 6, a tenant administrator accesses the platform to review a cap table containing sensitive stakeholder identities while maintaining visual privacy through the Encrypted View system's Three-Layer Privacy Stack (200).

As illustrated in FIG. 6, the Three-Layer Privacy Stack (200) comprises three independent, non-coupled layers, each addressing a distinct threat vector: Layer 1—Schema Isolation (202), wherein the tenant's data resides within a structurally isolated database schema (30, 32, or 34 as shown in FIG. 1), preventing cross-tenant data access at the database level regardless of any application-layer compromise; Layer 2—ZKP Verification (204), wherein equity assertions are verified via Zero-Knowledge Proofs generated through the NOIR Circuit Engine (40), ensuring that sensitive data is never exposed during processing-level operations; and Layer 3—Encrypted View/Visual Masking (206), wherein the display layer obscures stakeholder identities and equity data through HMAC-based hashing, preventing visual exposure of sensitive information during routine cap table interactions.

Referring further to FIG. 6, the administrator interacts with the Privacy Toggle (210) to transition between Normal View (208) and Masked View (214). Upon activation of the Masked View, the system engages the HMAC-SHA-256 Engine (212), which uses the tenant's companyId as the unique HMAC key. This company-specific keying ensures that identical stakeholder names across different tenants produce entirely different hash outputs, preventing cross-tenant correlation attacks.

As shown in FIG. 6, the Display Priority Chain (216) governs the rendering of masked identities through a three-tier fallback: Custom Label (218), wherein an administrator-assigned privacy label (e.g., “Investor Group A”) is preferentially displayed; Hash (220), wherein a truncated HMAC-SHA-256 hash in an unambiguous charset format (e.g., XXXX-XXXX) is displayed in the absence of a custom label; and Placeholder (222), wherein a generic placeholder is rendered if neither label nor hash is available, preventing any data leakage.

Access to modify privacy labels and toggle between Normal and Masked views is governed by Role-Based Access Control (224), enforced at the middleware layer via the requireRole mechanism. Staff-level users may view the Masked View but cannot edit labels; only administrators with tenant_admin or platform_admin roles may create or modify custom privacy labels through the label editing interface, which persists labels to the privacyLabels table within the tenant's isolated schema.

A distinguishing characteristic of this embodiment is the absence of coupling between the three privacy layers. The compromise of any single layer—for example, a failure in the visual masking toggle—does not jeopardize the integrity of the Schema Isolation (202) or ZKP Verification (204) layers. Each layer operates as an independent defense perimeter, providing defense-in-depth protection that is architecturally superior to conventional single-layer privacy controls employed by legacy equity management platforms.

### Embodiment 5: Computationally Invariant Four-Gate Middleware for Access Control

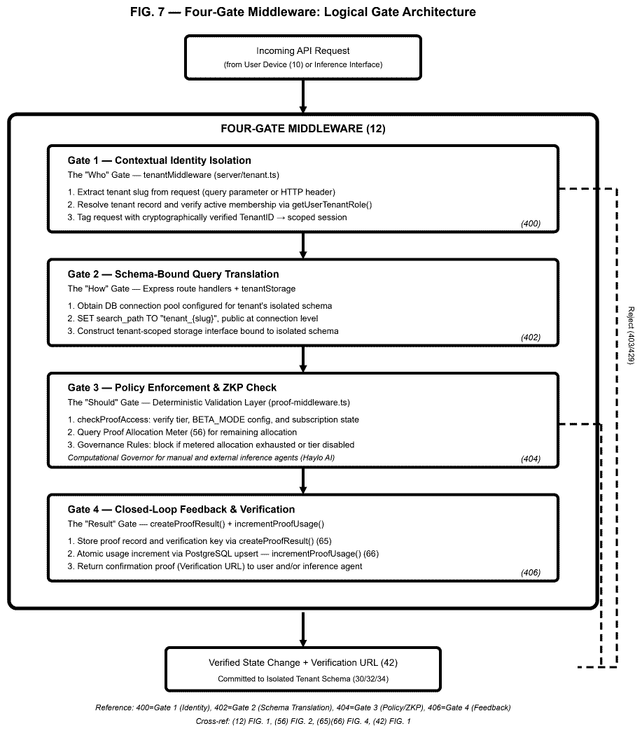

In a fifth embodiment, as shown in FIG. 7, the platform implements a computationally invariant four-gate middleware architecture (12) that governs all access to tenant data and cryptographic operations. This middleware operates as a sequential pipeline through which every API request—whether initiated by a manual user action or an external inference agent—must pass before any state change is committed to an isolated tenant schema.

As illustrated in FIG. 7, the first gate, Contextual Identity Isolation (400), is implemented through the tenantMiddleware function in server/tenant.ts. Upon receiving an API request, this gate extracts the tenant slug from the request (via query parameter or HTTP header), retrieves the corresponding tenant record, and calls getUserTenantRole( ) to verify that the authenticated user holds an active membership for the specified tenant. If no active membership exists, the request is rejected with a 403 status. Platform administrators (identified by an isPlatformAdmin flag) bypass this membership check, enabling cross-tenant administrative access. This gate transforms every incoming request into a scoped session, ensuring that even if an inference agent generates a request referencing a different company's data, the middleware blocks execution at the schema layer before any database operation occurs.

The second gate, Schema-Bound Query Translation (402), establishes the database connection context for the request. Upon successful membership verification in Gate 1, this gate obtains a database connection pool configured for the tenant's isolated schema. The pool's connection handler sets the PostgreSQL search_path to “tenant_{slug}”, public on every new connection, ensuring that all subsequent SQL queries within the request lifecycle are confined to the tenant's schema. The middleware then constructs a tenant-scoped storage interface (tenantStorage) bound to this connection and attaches it to the request object for use by downstream route handlers. This gate solves the technical problem of non-deterministic query routing in a multi-tenant environment by providing deterministic schema translation bound to the authenticated tenant context.

The third gate, Policy Enforcement and ZKP Check (404), functions as a Deterministic Validation Layer implemented through checkProofAccess in server/proof-middleware.ts. Before any computationally intensive cryptographic operation is executed, this gate performs three checks: (1) Tier Verification—the gate retrieves the tenant's current plan (set by the subscription pipeline) and calls getProofTierConfig( ) to obtain the corresponding configuration, including the noirEnabled flag and maxProofsPerMonth limit; (2) Meter Query—the gate queries the Proof Allocation Meter (56) to determine the tenant's remaining allocation for the current billing period; and (3) Governance Enforcement—if the tenant's tier does not permit cryptographic operations, or if the metered allocation is exhausted, the gate blocks the request before any circuit execution occurs. The Proof Allocation Meter (56) is further configured to act as a computational governor for external inference agents, ensuring that automated iterative simulations do not exceed allocated cryptographic resources.

The fourth gate, Closed-Loop Feedback and Verification (406), executes upon successful proof generation and comprises the storage and confirmation pipeline described in FIG. 4. This gate stores the proof record via createProofResult( ) (65), executes the atomic usage increment via incrementProofUsage( ) (66) using a PostgreSQL upsert that is race-condition-proof (68), and returns the Verification URL (42) to the requesting user or inference agent. This gate ensures that the system operates as a closed-loop: every state change initiated through the middleware (whether by a human user or an AI agent) is verified, stored, and metered before any result is returned.

As described in Section 5, the Four-Gate Middleware remains computationally invariant across Beta and Production configurations. A single compile-time boolean constant (BETA_MODE) toggles the permission matrix between modes. The middleware executes identical logic paths regardless of mode—only the tier-limit data retrieved by Gate 3 changes based on the BETA_MODE flag at module load time.

### TEXTUAL DESCRIPTIONS OF DIAGRAMS

To further enable understanding of the system, the following textual descriptions of diagrams illustrate key data flows and component interactions. These representations are derived from detailed interaction mappings in the system documentation and are intended to support the Examiner's comprehension of the invention's operation.

### Description of FIG. 1: System Component Interaction Flow

As shown in FIG. 1, this diagram depicts the multi-layered architecture of the platform across browser, server, and database layers. At the browser layer, the User Device (10) hosts four frontend pages—including the Privacy Vault Interface (54) (see FIG. 2) and the public verification page (PublicVerify.tsx)—along with a custom ZKP hook that initiates user requests. An optional Inference Interface annotation adjacent to the User Device (10) indicates the system's configuration to accept natural-language-to-middleware translation via an external inference agent, as described in a related patent application (Patent C). Arrows show API calls passing through the Four-Gate Middleware (12), which enforces Authentication, Authorization, Tenant Routing, and Rate Limiting before reaching the server layer.

At the server layer, the Application Server (20) processes requests through routes (proof-routes.ts), middleware (proof-middleware.ts), proof services (proof-service.ts), and configuration settings (proof-config.ts). As further shown in FIG. 4, the Application Server (20) interacts with the NOIR Circuit Engine (40) for cryptographic operations, receiving Incoming Proof Requests (60), validating parameters and loading circuits via proof-service. ts (62), and executing the ownership_threshold circuit (64).

Referring to FIG. 1, data flows to and from the database layer, represented as isolated tenant Database Schemas (30, 32, 34)—each containing over twenty tables (e.g., equity records, commitment hashes, proof requests, proof results, proof usage)—with no cross-tenant data access. As illustrated in FIG. 4, upon successful proof generation, proof records are stored (65), and usage is updated atomically via incrementProofUsage( ) (66), committing the usage counter within an atomic upsert (68). Return arrows indicate responses—including proofId and Verification URL (42)—back to the User Device (10), with privacy ensured at each step via Encrypted View or ZKP obscurity as governed by the Security Ritual UX states (80, 82, 84, 86) depicted in FIG. 5.

### Description of FIG. 4: Zkp Data Transformation Pipeline

This diagram illustrates the five-stage pipeline for ZKP generation as processed by the Application Server (20) and NOIR Circuit Engine (40) depicted in FIG. 1. Starting with a raw cap table record (e.g., stakeholder shares) retrieved from a tenant's isolated Database Schema (30), data moves through the following transformation stages:
Stage 1—Raw Record Extraction: The Application Server (20) retrieves the source equity record from the tenant's Database Schema (30), ensuring Schema-per-Tenant Isolation as shown in FIG. 1, with no cross-tenant access to adjacent schemas (32, 34).
Stage 2—Salt Generation: A 32-byte random salt is generated server-side within proof-service.ts (62) (see FIG. 4) to ensure cryptographic uniqueness per proof cycle.
Stage 3—SHA-256 Commitment Hashing: The salted record undergoes SHA-256 hashing for fast integrity verification, producing the commitment hashes stored alongside the Mock Securities Data Store (52) as depicted in FIG. 2.
Stage 4—Pedersen Commitment (BN254/Grumpkin Curve Pair): The hashed data is further processed into a Pedersen commitment using the Grumpkin elliptic curve (embedded in BN254) for circuit compatibility, enabling the NOIR Circuit Engine (40) to operate on the commitment without exposing raw values.
Stage 5—Cryptographic State Storage: The final cryptographic state—proof record and verification key—is stored in the tenant's Database Schema (30). Usage is tracked separately via an atomic PostgreSQL upsert (incrementProofUsage( )) (66) as shown in FIG. 4, ensuring the usage counter (68) is updated only upon successful proof generation.

Parallel paths diverge at Stage 3: the Sandbox path, as shown in FIG. 2, seeds synthetic proofs into the Mock Securities Data Store (52) via the seedZkpData( ) Initialization Function (50) without invoking the NOIR Circuit Engine (40)—no circuit execution occurs. The live path proceeds through the NOIR Circuit Engine (40), executing the ownership_threshold circuit (64) (see FIG. 4) for actual proof generation. Both paths converge in a unified verification pipeline, where the resulting proof is assigned a Verification URL (42) (see FIG. 1) and the Security Ritual UX transitions from the PROCESSING state (82) through the 98% CAP state (84) to the VERIFIED state (86) as depicted in FIG. 5.

### Description of FIG. 6: Encrypted View Privacy Toggle System

As shown in FIG. 6, this diagram illustrates the Three-Layer Privacy Stack (200) and the Encrypted View system described in Section 6. The diagram depicts three independent privacy layers: Schema Isolation (202) at the database level, ZKP Verification (204) at the processing level, and Encrypted View/Visual Masking (206) at the display level.

The data flow shows a Normal View (208) of cap table data transitioning through the Privacy Toggle (210) to a Masked View (214). The masking transformation is performed by the HMAC-SHA-256 Engine (212), which accepts stakeholder identity data and the tenant's companyId as the HMAC key, producing a deterministic but opaque hash output. The company-specific keying ensures that identical stakeholder names across different tenants produce entirely different masked representations, preventing cross-tenant correlation.

The Display Priority Chain (216) governs rendering through a three-tier fallback: Custom Label (218) is displayed preferentially if set by an administrator, followed by Hash (220) as a truncated HMAC output, followed by Placeholder (222) as a generic fallback. Role-Based Access Control (224) enforces that staff-level users may view masked data but only tenant_admin or platform_admin roles may edit labels through the Label Editing Interface (226).

The diagram emphasizes “No Layer Coupling” between the three privacy layers, ensuring that the compromise of any single layer does not jeopardize the integrity of the others.

### Description of FIG. 7: Four-Gate Middleware Logical Architecture

As shown in FIG. 7, this diagram illustrates the Four-Gate Middleware (12) as a sequential logical pipeline through which every API request must pass. The diagram shows an Incoming API Request (from User Device (10) or an Inference Interface) entering the middleware boundary and proceeding through four gates:
Gate 1—Contextual Identity Isolation (400): The tenantMiddleware extracts the tenant slug, retrieves the tenant record, and verifies the user's active membership via getUserTenantRole( ). Requests without valid membership are rejected with a 403 status. This gate scopes every request to a single tenant context.
Gate 2—Schema-Bound Query Translation (402): The middleware obtains a database connection pool for the tenant's isolated schema, sets the PostgreSQL search_path to “tenant_{slug}”, public, and constructs a tenant-scoped storage interface bound to the schema-specific connection.
Gate 3—Policy Enforcement and ZKP Check (404): The checkProofAccess middleware verifies the tenant's tier configuration, queries the Proof Allocation Meter (56) for remaining allocation, and enforces governance rules. This gate functions as a Computational Governor for both manual and external inference agent requests, blocking operations when the metered allocation is exhausted or the tier does not permit cryptographic operations.
Gate 4—Closed-Loop Feedback and Verification (406): Upon successful proof generation, proof records are stored via createProofResult( ) (65), usage is incremented atomically via incrementProofUsage( ) (66), and the Verification URL (42) is returned to the requestor. This gate ensures every state change is verified, stored, and metered.

The diagram includes reject paths from Gate 1 (403—unauthorized) and Gate 3 (429 —meter exhausted) that bypass the remaining gates and return error responses without executing any circuit or committing any state change.

What is claimed is:

1. A computer-implemented system for privacy-preserving equity management comprising:
a. a multi-tenant data store enforcing schema-per-tenant isolation wherein each tenant's equity records are stored in a dedicated database schema inaccessible to other tenants;
b. a zero-knowledge proof subsystem configured to generate cryptographic proofs attesting to properties of equity records without revealing underlying equity data, the subsystem implementing a multi-stage transformation pipeline;
c. a sandbox environment provisioned with synthetic equity data enabling functional evaluation of cryptographic operations prior to tenant commitment; and
d. a four-gate middleware pipeline interposed between client requests and equity data operations, the pipeline enforcing sequential validation through authentication, tenant resolution, subscription verification, and feature-flag evaluation gates.

2. The system of claim 1, wherein the schema-per-tenant isolation further comprises a tenant resolution gate that maps each authenticated request to a corresponding isolated database schema, preventing cross-tenant data leakage at the query execution layer.

3. The system of claim 1, wherein the multi-stage transformation pipeline comprises:
a. a first stage generating a Pedersen commitment from equity input values;
b. a second stage computing a BN254 elliptic-curve hash of the Pedersen commitment; and
c. a third stage producing a Grumpkin-curve verification artifact suitable for on-chain or off-chain verification.

4. The system of claim 1, wherein the zero-knowledge proof subsystem performs server-side proof generation such that private equity data never leaves the server boundary, and only the resulting proof artifact is transmitted to a requesting client.

5. The system of claim 1, further comprising dual verification paths including:
a. an internal verification path accessible to authenticated tenant users for validating proofs against tenant-specific equity records; and
b. a public verification path accessible without authentication for validating proof artifacts using only the proof identifier and public verification parameters.

6. The system of claim 1, wherein the zero-knowledge proof subsystem implements at least:
a. a test_hash circuit configured to verify that a committed value matches a hash without revealing the value; and
b. an ownership_threshold circuit configured to prove that an ownership percentage exceeds a specified threshold without revealing the actual percentage.

7. The system of claim 1, wherein the sandbox environment is provisioned with seeded mock data comprising synthetic stakeholder records, equity instruments, and share classes, enabling a prospective tenant to execute cryptographic proof operations against realistic but non-production data.

8. The system of claim 7, wherein the sandbox environment further comprises an atomic usage tracking mechanism that meters each cryptographic operation performed within the sandbox against a per-tenant allocation, the allocation being enforced independently of production billing cycles.

9. The system of claim 1, wherein the four-gate middleware pipeline comprises:
a. a first gate performing session-based authentication and session validation;
b. a second gate resolving the authenticated user to a specific tenant schema;
c. a third gate verifying the tenant's active subscription status and proof allocation limits; and
d. a fourth gate evaluating compile-time and runtime feature flags to determine operation availability.

10. The system of claim 1, further comprising a compile-time boolean configuration toggle that enables or disables the zero-knowledge proof subsystem across the entire platform, wherein disabling the toggle renders all proof-related API endpoints inoperative without requiring code changes to individual route handlers.

11. The system of claim 1, further comprising an encrypted view layer implementing HMAC-SHA-256 signatures over displayed equity values, wherein the system maintains both a raw equity value and a privacy-preserving display value for each record, the display value being selectable based on tenant privacy configuration.

12. The system of claim 11, wherein the encrypted view layer implements a display priority chain that selects among: a fully encrypted representation, a partially masked representation, and a raw value representation, the selection being determined by the intersection of tenant-level privacy settings and the requesting user's role-based permissions.

13. The system of claim 1, further comprising a testing and validation infrastructure that maintains a mapping between each security property of the system and at least one automated test, the mapping being persisted as a machine-readable artifact enabling continuous verification of security invariants.

14. The system of claim 13, wherein the testing and validation infrastructure implements a security property mapping that associates each middleware gate, each cryptographic operation, and each tenant isolation boundary with a corresponding set of test assertions, the mapping being enforced at build time.

15. The system of claim 1, further comprising a multi-layered component architecture wherein:
a. a presentation layer renders equity data according to tenant privacy settings;
b. a logic layer enforces business rules including vesting computations and ownership calculations; and
c. a data access layer routes all queries through the tenant-resolved schema, the three layers being independently testable and deployable.

16. The system of claim 1, further comprising a version lock documentation system that records, for each deployed version of the system, the specific versions of cryptographic libraries, circuit definitions, and middleware configurations in use, enabling reproducible proof verification across software updates.

17. A computer-implemented method for privacy-preserving equity management,
comprising:
a. instantiating, via a four-gate middleware pipeline, a dedicated database schema for a first tenant to ensure logical isolation from a second tenant;
b. processing, through a multi-stage cryptographic pipeline, a request to verify an equity property by generating a zero-knowledge proof using a Pedersen commitment on a BN254/Grumpkin elliptic curve pair;
c. verifying the zero-knowledge proof against the equity property without exposing raw equity data, the verification being available through both an internal authenticated path and a public unauthenticated path; and
d. metering the generation of the zero-knowledge proof against a tenant-specific allocation using an atomic usage tracking mechanism that increments a usage counter only upon successful proof generation.

18. A non-transitory computer-readable medium storing instructions that, when executed by one or more processors, cause the processors to perform operations comprising:
a. resolving an authenticated user request to a specific isolated database schema via a four-gate middleware pipeline that enforces sequential validation through authentication, tenant resolution, subscription verification, and feature-flag evaluation gates;
b. generating a zero-knowledge proof attesting to a property of an equity record within the resolved database schema using a NOIR circuit framework, the proof being generated server-side such that private equity data never leaves the server boundary;
c. providing a verification URL for the zero-knowledge proof to a third party for public verification without exposing underlying equity data; and
d. enforcing a computational governance limit on the number of cryptographic operations permitted within a billing cycle, the limit being determined by the intersection of a compile-time configuration toggle and the tenant's subscription tier.

19. The system of claim 1, wherein the sandbox environment includes a Security Ritual user interface that displays a progress-bounded animation programmatically capped at a near-completion threshold via a requestAnimationFrame-based mechanism while a server-side circuit engine generates a proof, and transitions to a verified state displaying a verification URL only upon receipt of a cryptographic verification artifact from the server, thereby providing visual evidence of mathematical integrity to the user.

20. The system of claim 7, wherein the sandbox environment utilizes a separate time-to-live policy for pre-seeded synthetic proofs that exceeds the time-to-live policy for production-generated proofs, enabling extended evaluation periods for stealth-stage stakeholders while maintaining shorter retention cycles for live cryptographic operations.
